(19) United States
(12) Patent Application Publication
(10) Pub. No.: US 2009/0257801 A1
(43) Pub. Date: Oct. 15, 2009

(54) IMAGE FORMING APPARATUS AND CURL STRAIGHTENING DEVICE

(75) Inventors: Noriyuki Miyoshi, Ebina (JP); Norio Ogawahara, Ebina (JP); Nobuyoshi Komatsu, Ebina (JP); Masakatsu Eda, Ebina (JP); Tatsunori Izawa, Ebina (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd., Tokyo (JP)

(21) Appl. No.: 12/359,627

(22) Filed: Jan. 26, 2009

(30) Foreign Application Priority Data
Apr. 10, 2008 (JP) 2008-102773

(51) Int. Cl. G03G 15/00

(52) U.S. Cl. 399/406

(57) ABSTRACT

An image forming apparatus includes: a sheet conveyance section that conveys a sheet; an image forming section that forms an image on the sheet conveyed by the sheet conveyance section according to an image signal; a sheet heating section that heats the sheet on which the image is formed by the image forming section; and a curl straightening section that straightens curl of the sheet after the sheet is heated by the sheet heating section. The sheet heating section curls the sheet in a different direction according to a sheet thickness. The curl straightening section includes: a first curl straightening section that straightens the curl of the sheet curled in a first direction for curling thick sheet; and a second curl straightening section disposed on a downstream side in a sheet conveyance direction to straighten the curl of the sheet curled in a second direction opposite to the first direction.

### CROSS-REFERENCE TO RELATED APPLICATIONS

This application is based on and claims priority under 35 U.S.C. 119 from Japanese Patent Application No. 2008-102773 filed Apr. 10, 2008.

### BACKGROUND

(i) Technical Field

The present invention relates to an image forming apparatus provided with a curl straightening section that straightens curl of a sheet after fixing and a curl straightening device that straightens the curl of the sheet to which a toner image is fixed.

(ii) Related Art

In an image forming apparatus used for an electrophotographic copying machine and a printer, a photosensitive body is charged, an electrostatic latent image is formed in a surface of the photosensitive body by image exposure, development is performed with toner to form a toner image, the toner image is transferred onto a sheet directly or with an intermediate transfer body interposed therebetween, the sheet to which the toner image is transferred is heated and pressurized to fix the toner image onto the sheet, and an image is formed on the sheet. A fixing device including a heating roller and a pressurizing roller or a pressurizing belt is widely used as a fixing section that fixes the toner image transferred onto the sheet. The heating roller is rotated while a heater is incorporated therein. The pressurizing roller or the pressurizing belt 1s disposed opposite the heating roller and presses the heating roller, with the sheet interposed between the pressurizing roller or the pressurizing belt and the heating roller.

And the image forming apparatus includes a curl straightening device that straightens the curl of the sheet after the fixing.

### BRIEF DESCRIPTION OF THE DRAWINGS

An exemplary embodiment of the present invention will be described in detail based on the following figures, wherein:

FIG. 1 is a schematic diagram showing an image forming apparatus according to an exemplary embodiment of the invention;

FIG. 2 shows configurations of a fixing section and a curl straightening section of FIG. 1;

FIG. 3 shows five bite positions of an upper-curl straightening cam and a motor of FIG. 2;

FIG. 4 shows five bite positions of a down-curl straightening cam and a motor of FIG. 2;

FIG. 5 shows a penetration combination table formed by a combination of the five bite positions of the upper-curl straightening cam and the five bite positions of the down-curl straightening cam;

FIG. 6 shows a relationship of a curl amount with a distance between the fixing device and an upper-curl straightening section for each type of sheet, using numerical values;

FIG. 7 is a graph showing the relationship of the curl amount with the distance between the fixing device and the upper-curl straightening section for each type of sheet;

FIG. 8 shows a display section of GUI shown in FIG. 1;

FIG. 9 shows a main unit of FIG. 1 and an interface module attached to the main unit; and

FIG. 10 is a table showing a correlation between a sheet size (large-size and small-size) and a fiber grain direction.

### SUMMARY

An image forming apparatus includes:

a sheet conveyance section that conveys a sheet;

an image forming section that forms an image on the sheet conveyed by the sheet conveyance section according to an image signal;

a sheet heating section that heats the sheet on which the image is formed by the image forming section; and

a curl straightening section that straightens curl of the sheet after the sheet is heated by the sheet heating section,

wherein the sheet heating section curls the sheet in a different direction according to a sheet thickness, and

the curl straightening section includes:

a first curl straightening section that straightens the curl of the sheet curled in a first direction, the first direction being of a direction in which a relatively thick sheet is curled by the sheet heating section; and

a second curl straightening section that is disposed on a downstream side in a sheet conveyance direction of the sheet conveyance section to straighten the curl of the sheet curled in a second direction, the second direction being of an opposite direction to the first direction.

### DETAILED DESCRIPTION

An exemplary embodiment of the invention will be described below.

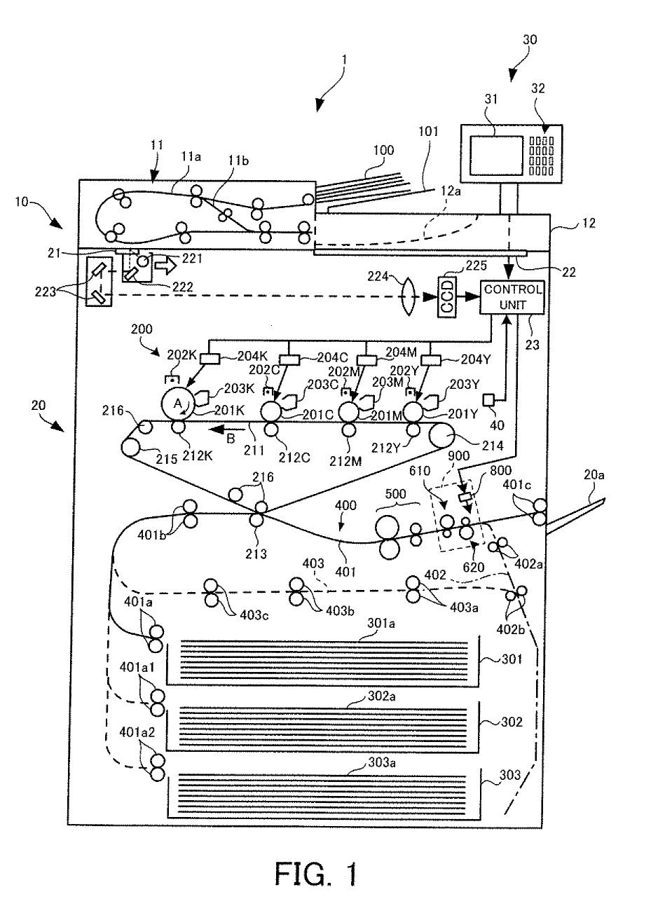

FIG. 1 is a schematic diagram showing an image forming apparatus according to an exemplary embodiment of the invention.

FIG. 1 shows a copying machine 1 of the exemplary embodiment, and a curl straightening device of the exemplary embodiment is mounted on the copying machine 1. The copying machine 1 includes an original seeding unit 10, a main unit 20, and GUI (Graphical User InterFace) 30. The original feeding unit 10 includes a sheet feeding section 101 on which one or plural originals are placed. The main unit 20 is disposed below the original feeding unit 10. GUI 30 includes a display section 31 on which various pieces of information are displayed and a manipulation section 32 having various manipulation keys.

The original feeding unit 10 includes an automatic original feeding unit 11 and a housing 12. The automatic original feeding unit 11 sequentially feeds an original 100 placed on the sheet feeding section 101 along a conveyance path 11a. In the original feeding unit 10, the original 100 conveyed along the conveyance path 11a is discharged to an upper surface 12a of the housing 12. When a user provides an instruction to read images in the surface and backside of the original 100, the automatic original feeding unit 11 feeds the original 100 that is once passed through the conveyance path 11a to a reversal conveyance path 11b to reverse the original 100, and the automatic original feeding unit 11 conveys the original 100 along the conveyance path 11a again.

The main unit 20 includes a sheet discharge stage 20a. The sheet discharge stage 20a is disposed on the backside of the main unit 20, and the sheet in which the image is recorded is discharged on the sheet discharge stage 20a. The main unit 20 includes a contact glass 21 and a platen glass 22. The contact glass 21 is provided at position facing the original conveyed by the original feeding unit 10. The platen glass 22 is provided adjacent to the contact glass 21, and the user places the original one by one on the platen glass 22. The main unit 20 includes a light source 221, a reflecting mirror 222, a pair of reflecting mirrors 223, a lens 224, a Charge Coupled Device (CCD) 225, and a control section 23. The light source 221 is disposed while extended from the front side of FIG. 1 to the rear side, and the light source 221 illuminate the original 100 with exposure light. The reflecting mirror 222 orientates the light reflected from the original 110 toward a horizontal direction. The pair of reflecting mirrors 223 reversely orientates the reflected light that is orientated toward the horizontal direction by the reflecting mirror 222. The lens 224 forms an image of the light reflected from the reflecting mirror 223. The CCD 225 is an image receiving sensor which receives the light image formed by the lens 224 and supplies image data. The control section 23 performs image processing to analog image data supplied from the CCD 225, and the control section 23 controls the whole of the main unit 20.

The main unit 20 includes an environmental sensor 40 that detects environmental temperature and humidity of the image forming apparatus 1. Temperature information and humidity information indicating the temperature and humidity detected by the environmental sensor 40 are fed into the control section 23.

The main unit 20 includes an image forming section 200 (corresponding to an example of the image forming section and transfer section of the invention) which forms a toner image according to an image signal to transfer the toner image onto the sheet. The image forming section 200 includes photosensitive bodies 201Y, 201M, 201C, and 201K that are rotated in a direction of an arrow A, charging devices 202Y, 202M, 202C, and 202K that apply charges to the photosensitive bodies 201Y, 201M, 201C, and 201K, development devices 203Y, 203M, 203C, and 203K in which color toners Y, X, C, and K are respectively stored, and exposure sections 204Y, 204M, 204C, and 204K that irradiate the photosensitive bodies 201Y, 201M, 201C, and 201K with exposure light based on the image data from the control section 23. The image forming section 200 includes an intermediate transfer belt 211 that is circulated in a direction of an arrow B and primary transfer rollers 212Y, 212M, 212C, and 212K that are located across the intermediate transfer belt 211 from the photosensitive bodies 201Y, 201M, 201C, and 201K. The copying machine 1 an print a full-color image. The characters Y, M, C, and K appended to tail ends of the components designate yellow, magenta, cyan, and black image forming components, respectively.

The image forming section 200 includes a secondary transfer roller 213, a driving roller 214, a tension roller 215, and an idle roller 216. The secondary transfer roller 213 secondary-transfers the toner image that is primary-transferred onto the intermediate transfer belt 211 to the sheet. The driving roller 214 drives the intermediate transfer belt 211. The tension roller 215 is used to tension the intermediate transfer belt 211.

In the image forming section 200, the charging devices 202Y, 202M, 202C, and 202K apply predetermined charges to surfaces of the photosensitive bodies 201Y, 201M, 201C, and 201K rotated in the direction of the arrow A, the exposure sections 204Y, 204M, 204C, and 204K irradiate the surfaces of the photosensitive bodies 201Y, 201M, 201C, and 201K with the exposure light to form electrostatic latent images, the electrostatic latent images are developed with toner stored in the development devices 203Y, 203M, 203C, and 203K, color toner images are obtained by primary-transferring the developed images onto the intermediate transfer belt 211 circulated in the direction of the arrow B using the primary transfer roller 212Y, 212M, 212C, and 212K, and the secondary transfer roller 213 secondary-transfers the color toner images onto the sheet.

Three sheet cassettes 301, 302, and 303 can be attached to the main unit 20, three types of the sheets 301a, 302a, and 303a having different sizes are stored in the sheet cassettes 301, 302, and 303. The image can be formed while the sheet cassette in which the desired sheet is contained is specified.

The main unit 20 includes a sheet conveyance section 400 (corresponding to an example of the sheet conveyance section of the invention) that conveys the sheet, a fixing section 500 (corresponding to an example of the fixing section of the invention), and a curl straightening section 900 (corresponding to an exemplary embodiment of the curl straightening device of the invention).

The sheet conveyance section 400 includes a first conveyance path 401, a second conveyance path 402, and a third conveyance path 403.

The first conveyance path 401 is one through which the sheet is conveyed when an instruction to record the image in a single side of the sheet is provided. The first conveyance path 401 includes conveyance rollers 401a (or conveyance rollers 401a1 and 401a2) and 401b, and a discharge roller 401c.

When an instruction to record the images in both sides of the sheet is provided, the sheet in which the fixing is completed to the surface is guided to not the sheet discharge stage 20a but the second conveyance path 402 to record the image in the backside of the sheet. The second conveyance path 402 includes conveyance rollers 402a and 402b.

The third conveyance path 403 is one through which the sheet guided to the second conveyance path 402 is conveyed, the sheet is inverted and delivered to the first conveyance path 401 again through the third conveyance path 403, and the image is recorded in the backside of the sheet. The third conveyance path 403 includes conveyance rollers 403a, 403b, and 403c.

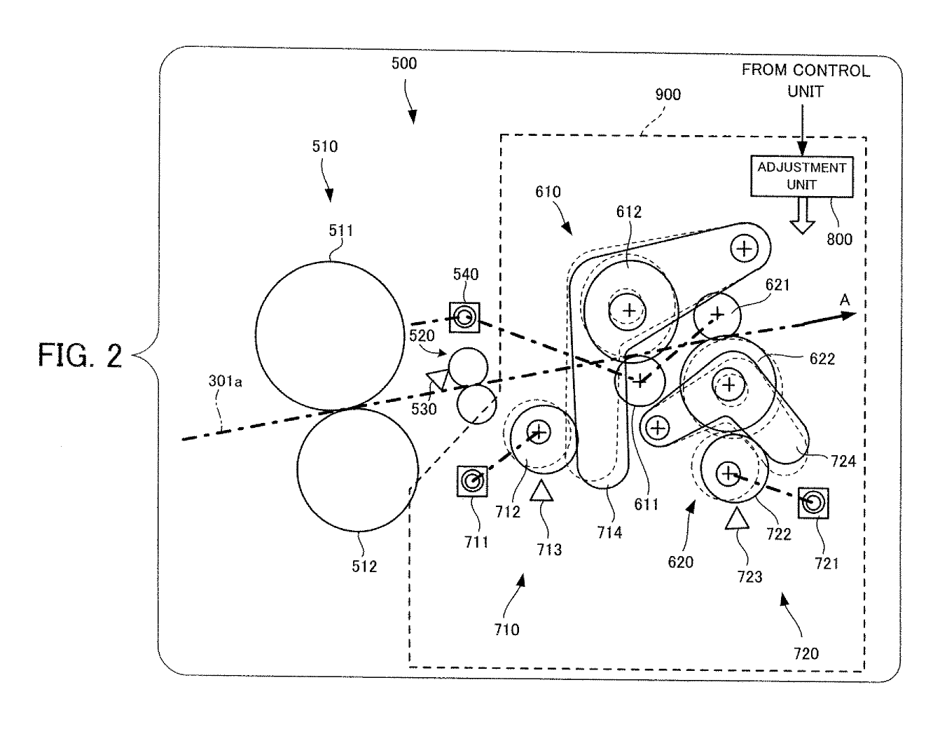

The fixing section 500 and the curl straightening section 900 will be described with reference to FIG. 2.

FIG. 2 shows configurations of a fixing section and a curl straightening section of FIG. 1.

Referring to FIG. 2, the fixing section 500 includes a fixing device 510, a pair of discharge rollers 520, a discharge sensor 530, and a discharge motor 540. The fixing device 510 includes a heating roller 511 and a pressurizing roller (or pressurizing belt) 512. The sheet 301a to which the color toner image is transferred (secondary transfer) by the secondary transfer roller 213 is conveyed from the left of FIG. 2 to the fixing device 510. In the fixing device 310, the sheet 301a is pressurized by the pressurizing roller 512 while heated by the heating roller 511, and the toner image is fixed on the sheet 301a. In the fixing section 500, when the sheet 301a to which the toner image is fixed is thick, the sheet 301a is upper-curled (upwardly projected curl). On the other hand, when the sheet 301a to which the toner image is fixed is thin, the sheet 301a is down-curled (downwardly projected curl). The sheet 301a to which the toner image is fixed is discharged by discharge rollers 521 and 522, and the discharge sensor 530 detects that the sheet 301a is discharged from the fixing device 510. Therefore, the motor 540 states rotation, and the curl straightening section 900 starts an operation.

The curl straightening section 900 includes an upper-curl straightening section 610 (an example of the first curl straightening section of the invention), a down-curl straightening section 620 (an example of the second curl straightening section of the invention), and an adjustment section 800 (an example of the adjustment section of the invention). The upper-curl straightening section 610 straightens the curl of the upper-curled sheet 301a (an example of the sheet curled in the first direction of the invention). The down-curl straightening section 620 straightens the curl of the down-curled sheet 301a (an example of the sheet curled in the second direction of the invention). The down-curl straightening section 620 is disposed on the downstream side in the sheet conveyance direction of the upper-curl straightening section 610. Particularly, the upper-curl straightening section 610 and the down-curl straightening section 620 straighten the curl of the sheet 301a by applying a straightening force for warping the upper-curled sheet 301a in the reversal direction and a straightening force for warping the down-curled sheet 301a in the reversal direction, respectively. As described later, the straightening force is freely adjusted. The upper-curl straightening section 610 and the down-curl straightening section 620 are formed into one assembly.

As described above, the thick sheet 301a discharged from the fixing section 500 is upper-curled. As the thickness of the sheet 301a is increased, the curl straightening becomes harder. As a temperature at the sheet 301a is lowered, the curl straightening becomes harder. Therefore, in the exemplary embodiment, the upper-curl straightening section 610 is disposed on the downstream side in the sheet conveyance direction of the fixing section 500, and the down-curl straightening section 620 is disposed on the downstream side in the sheet conveyance direction of the upper-curl straightening section 610, so that the upper-curl straightening section 610 performs the upper-curl straightening of the upper-curled thick sheet 301a discharged from the fixing section 500 when the sheet 301a has a high temperature. On the other hand, the thin sheet 301a discharged from the fixing section 500 is down-curled. At this point, the curl straightening is performed to the thin sheet 301a even if the sheet 301a has a low temperature. Therefore, even if the temperature is lowered at the down-curled thin sheet 301a passed through the upper-curl straightening section 610, the down-curl straightening section 620 performs the down-curl straightening of the thin sheet 301a.

The detailed description will be made. The upper-curl straightening section 610 includes a metal curl straightening shaft 611 and a curl straightening roller 612 made of an elastic material. The curl straightening shaft 611 drives the conveyed sheet 301a. On the other hand, the curl straightening roller 612 is disposed in parallel with the curl straightening shaft 611, the curl straichtening roller 612 is driven by the curl straightening shaft 611 while the sheet 301a is nipped between the curl straightening shaft 611 and the curl straightening roller 612, and the curl straightening roller 612 presses the sheet 301a against the curl straightening shaft 611. The curl straightening roller 612 has a diameter larger than that of the curl straightening shaft 611. In the curl straightening roller 612, the nip portion with the curl straightening shaft 611 is recessed along a shape of the curl straightening shaft 611. The upper-curl straightening section 610 includes a cam mechanism 710 (an example of the first cam mechanism of the invention). The cam mechanism 710 includes an upper-curl straightening motor 711, a cam 112, a cam position sensor 713, and a lever 714. The cam mechanism 710 applies a first pressing force to the curl straightening roller 612 according to a position of the cam 712 in order to press the curl straightening shaft 611 through the cam 712 and the lever 714.

On the other hand, the down-curl straightening section 620 includes a metal curl straightening shaft 621 and a curl straightening roller 622 made of an elastic material. The curl straightening shaft 621 drives the sheet 301a while contacting a second surface of the sheet 301a. The second surface is the backside of a first surface of the conveyed sheet 301a, and the curl straightening shaft 621 contacts the first surface. On the other hand, the curl straightening roller 622 is disposed in parallel with the curl straightening shaft 621, the curl straightening roller 622 is driven by the curl straightening shaft 621 while the sheet 301a is nipped between the curl straightening shaft 621 and the curl straightening roller 622, and the curl straightening roller 622 presses the sheet 301a against the curl straightening shaft 621. The curl straightening roller 622 has a diameter larger than that of the curl straightening shaft 621. In the curl straightening roller 622, the nip portion with the curl straightening shaft 621 is recessed along the shape of the curl straightening shaft 621. The down-curl straightening section 620 includes a cam mechanism 720 (an example of the second cam mechanism of the invention). The cam mechanism 720 includes a down-curl straightening motor 721, a cam 722, a cam position sensor 723, and a lever 724. The cam mechanism 720 applies a second pressing force to the curl straightening roller 622 according to the position of the cam 722 in order to press the curl straightening shaft 621 through the cam 722 and the lever 724.

The adjustment section 900 included in the curl straightening section 900 obtains thickness information (grammage) on the sheet 301a from a user input through GUI 30 of FIG. 1. The adjustment section 800 obtains image density information from the control section 23. The image density information indicates a ratio of a toner adhesion area on the sheet 301a to an area of the sheet 301a. The adjustment section 800 obtains temperature information detected by the environmental sensor 40 from the control section 23.

The adjustment section 800 adjusts the straightening forces of the upper-curl straightening section 620 and down-curl straightening section 620 according to the thickness information, the image density information, and the humidity information.

A series of operations performed by the fixing section 500 and curl straightening section 900 will be described. The sheet 301a to which the toner image is transferred is conveyed to the fixing device 510, and the fixing device 510 fixes the toner image onto the sheet 301a. The fixing device 510 constitutes the fixing section 500, and the fixing device 510 includes a heating roller 511 and a pressurizing roller 512. The sheet 301a to which the toner image is fixed is discharged to ward the curl straightening section 900 by the pair of discharge rollers 521 and 522. The discharge sensor 530 detects that the sheet 301a is discharged from the fixing device 510. Therefore, the discharge motor 540 starts the rotation, thereby starting the rotations of the curl straightening shafts 611 and 621 constituting the curl straightening section 900. At the beginning, the upper-curl straightening cam 712, the lever 714, and the curl straightening roller 612 are located at positions shown by dotted lines of FIG. 2. The down-curl straightening cam 722, the lever 724, and the curl straightening roller 622 are located at positions shown by dotted lines of FIG. 2.

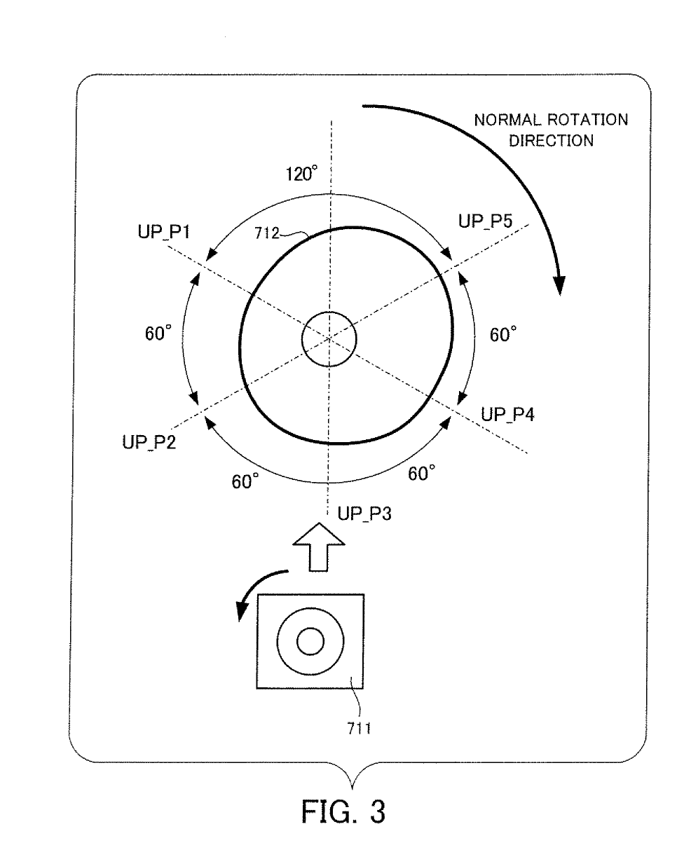

At this point, an upper-curl amount and a down-curl amount of the sheet 301a discharged from the fixing device 510 are previously estimated according to conditions such as the sheet material, the grammage, and the sheet size. The motor 711 is rotated while the position of the cam 712 is detected by the cam position sensor 713 such that correction is performed according to the estimated upper-curl amount. Therefore, the cam 712 is rotated to the position shown by a solid line from the position shown by the dotted line of FIG. 2. This enables the lever 714 to be displaced to the position shown by a solid line from the position shown by the dotted line of FIG. 2. Then the curl straightening roller 612 is moved to the position shown by a solid line from the position shown by the dotted line of FIG. 2. Accordingly, the curl straightening roller 612 contacts the curl straightening shaft 611 with a predetermined bite amount (penetration amount), and the curl straightening shaft 611 is rotated to drive the curl straightening roller 612, thereby performing the upper-curl straightening of the sheet 301a. Similarly to the upper-curl straightening, the down-curl straightening is performed. At this point, the down-curl straightening motor 721, the cam 722, the cam position sensor 723, and the lever 724 play roles of the upper-curl straightening motor 711, cam 712, cam position sensor 713, and lever 714, whereby the correction is performed according to the estimated down-curl amount. The detailed description will be made with reference to FIGS. 3 to 5.

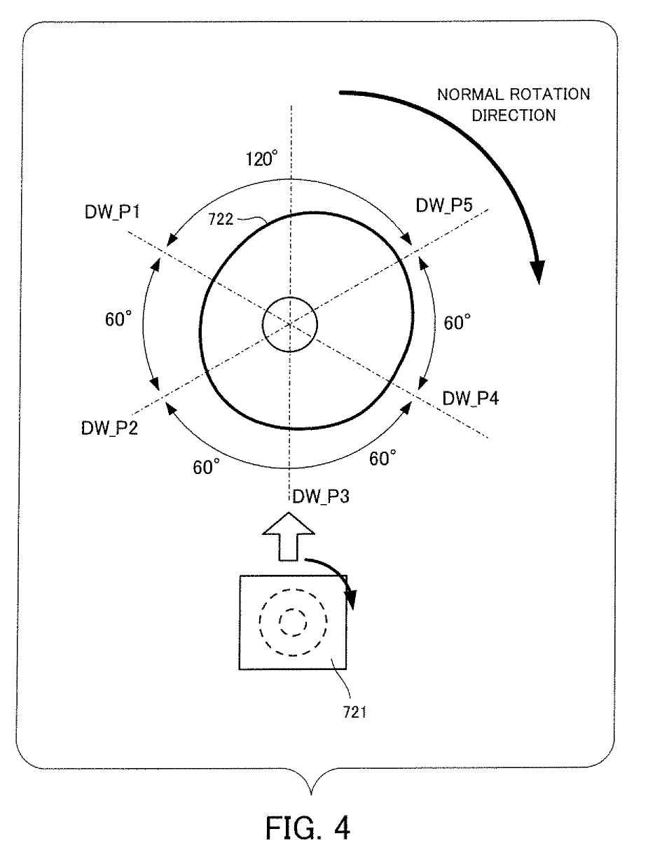

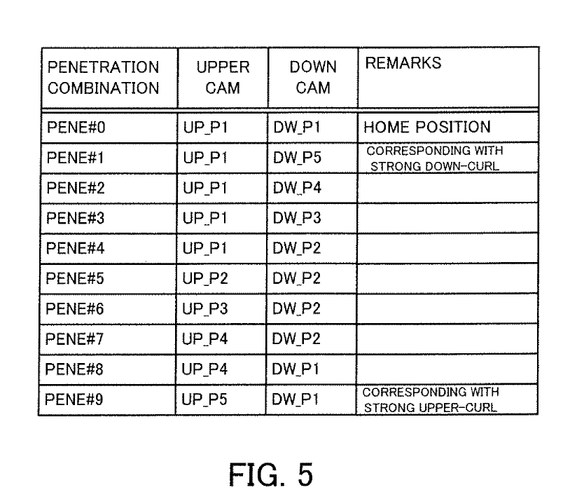

FIG. 3 shows five bite positions of the upper-curl straightening cam and the motor in FIG. 2, and FIG. 4 shows five bite positions of the down-curl straightening can and the motor in FIG. 2. FIG. 5 shows a penetration combination table formed by a combination of the five bite positions of the upper-curl straightening cam and the five bite positions of the down-curl straightening cam.

FIG. 3 shows five bite amount positions UP_P1, UP_P2, UP_P3, UP_P4, and UP_P5 of the upper-curl straightening cam 712 in FIG. 2. The bite amount position UP_P1 is a so-called home position, and the cam 712 is located at the position shown by the dotted line of FIG. 2. When the cam 712 is located at the home position, the sheet 301a is directly discharged while the upper-curl straightening is not performed to the conveyed sheet 301a.

The motor 711 is rotated counterclockwise when viewed from the rotating shaft direction. Then the cam 712 is rotated clockwise (normal rotation direction). In rotating the cam 712 in the normal rotation direction, the bite amount position becomes UP_P1→UP_P2→UP_P3→UP_P4→UP_P5. At this point, the bite amount becomes the minimum at the bite amount position UP_P1 (no bite amount), and the bite amount is increased in the order of UP_P2→UP_P3→UP_{—P4→UP}_P5.

FIG. 4 shows five bite amount positions DW_P1, DW_P2, DW_P3, DW_P4, and DW_P5 of the down-curl straightening cam 722 in FIG. 2. The bite amount position DW_P1 is a so-called home position, and the cam 722 is located at the position shown by the dotted line of FIG. 2. When the cam 722 is located at the home position, the sheet 301a is directly discharged while the down-curl straightening is not performed to the conveyed sheet 301a.

The motor 721 is rotated clockwise when viewed from the rotating shaft direction. Then the cam 722 is rotated clockwise (normal rotation direction). In rotating the cam 722 in the normal rotation direction, the bite amount position becomes DW_P1→DW_P2→DW_P3→DW_P4→DW_P5. At this point, the bite amount becomes the minimum at the bite amount position DW_P1 (no bite amount), and the bite amount is increased in the order of DW_P2→DW_P3→DW_P4→DW_P5.

A penetration combination table of FIG. 5 is obtained by a combination of the five bite amount positions UP_P1, UP_P2, UP_P3, UP_P4, and UP_P5 of the upper-curl straightening cam 712 and the five bite amount positions DW _P1, DW_P2, DW_P3, DW_P4, and DW_25 of the down-curl straightening cam 722.

In a penetration combination PENE#0 of FIG. 5, the upper-curl straightening cam 712 and the down-curl straightening cam 722 are located at the bite amount positions UP_P1 and DW_P1 (home position), respectively. In the penetration combination PENE#0, the sheet 301a is directly discharged with no curl straightening applied thereto. In a penetration combination PENE#1, the upper-curl straightening cam 712 and the down-curl straightening cam 722 are located at the bite amount positions UP_P1 and DW_P5, respectively. The penetration combination PENE#1 can deal with the strong down-curl straightening of the sheet 301a. On the other hand, in a penetration combination PENE#9, the upper-curl straightening cam 712 and the down-curl straightening cam 722 are located at the bite amount positions UP_P5 and DW_P1, respectively. The penetration combination PENE#9 can deal with the strong upper-curl straightening of the sheet 301a. Thus, the penetration combination PENE#1 through the penetration combination PENE#9 correspond to “corresponding with strong down-curl straightening” through “corresponding with strong upper-curl straightening”.

At this point, the upper-curl amount and the down-curl amount of the sheet 301a discharged from the fixing device 510 are previously estimated according to conditions such as the sheet material, the grammage, and the sheet size, and one of the penetration combination PENE#1 to the penetration combination PENE#9 is selected according to the estimated upper-curl amount and down-curl amount to straighten the upper-curl and down-curl of the sheet 301a. Therefore, the curl straightening is performed to the sheet 301a that is curled in a different direction according to the thickness.

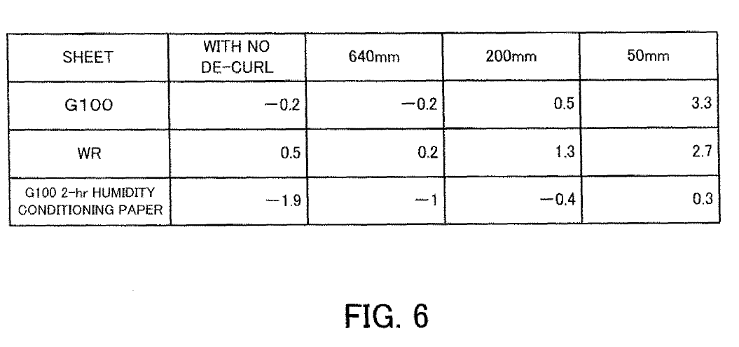

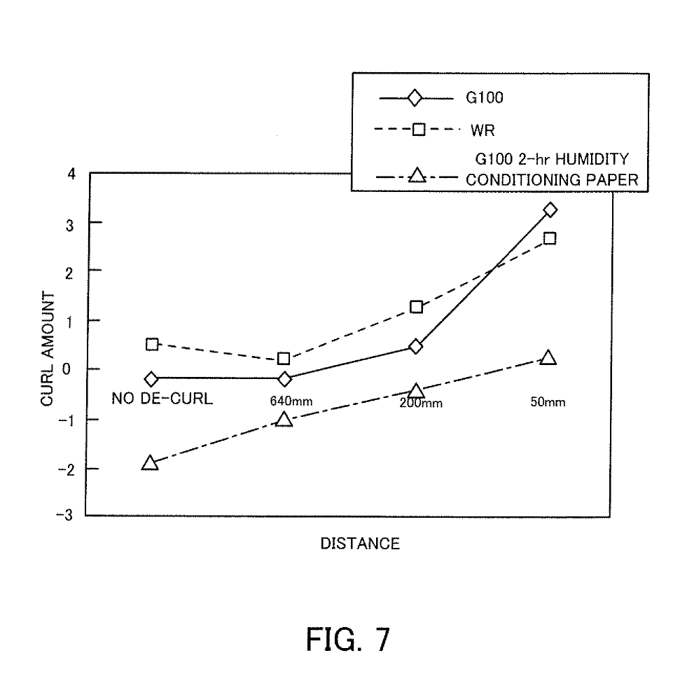

FIG. 6 shows a relationship of the curl amount with the distance between the fixing device and the upper-curl straightening section in terms of a numerical value in each type of sheet, and FIG. 7 is a graph showing the relationship of the curl amount with the distance between the fixing device and the upper-curl straightening section in each type of sheet.

FIG. 6 shows the case in which only the fixing device 510 is used (with no de-curler (with no upper-curl straightening section 610)) a relationship of the curl amount with the distance of 640 mm between the fixing device 510 and the upper-curl straightening section 610, a relationship of the curl amount with the distance of 200 mm between the fixing device 510 and the upper-curl straightening section 610, and a relationship of the curl amount with the distance of 50 mm between the fixing device 510 and the upper-curl straightening section 610 in terms of a numerical value in various sheets (G100, WR, and humidity conditioning paper (G100 in which humidity is contained for two hours)). FIG. 7 is a graph showing the relationships between the distances and the curl amounts. As can be seen from FIGS. 6 and 7, as the distance between the fixing device 510 and the upper-curl straightening section 610 is shortened, the curl straightening force is increased. As can be seen from FIGS. 6 and 7, it is necessary to adjust the bite amount (penetration amount) according to the sheet type and the humidity conditioning. In the exemplary embodiment, the curl straightening is performed in consideration of these points.

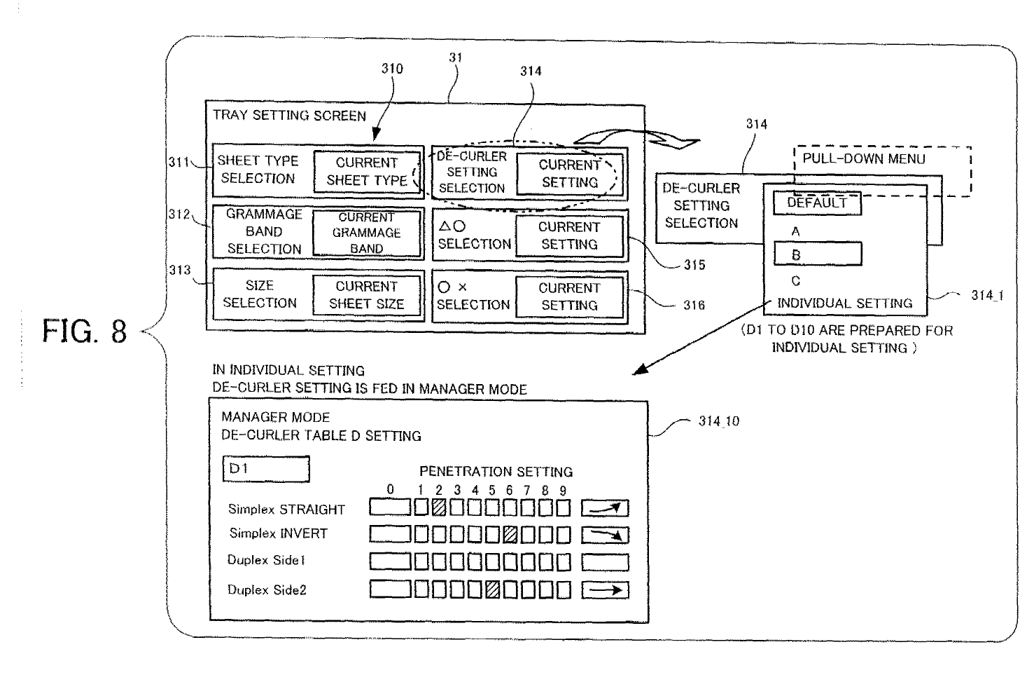

FIG. 8 shows a display section of the GUT illustrated in FIG. 1.

Referring to FIG. 8, a tray setting screen 310 is displayed on the display section 31 of GUI 30. The tray setting screen 310 includes a sheet type selection section 311, a grammage band selection section 312, a size selection section 313, a de-curler setting selection section 314, and other selection sections 315 and 316. The de-curler setting selection section 314 is formed in a pull-down menu type, and a predetermined pull-down menu 314_1 of FIG. 8 is displayed when the de-curler setting selection section 314 is manipulated. A default (standard curl correction), three preset stages, that is, an A setting, a B setting, and a C setting of curl correction strength, and an individual setting are displayed on the pull-down menu 314_1. Ten de-curler tables D1 to D10 in which the user can set the desired curl correction are prepared in the individual setting. At this point, a manager mode screen 314_10 is displayed when the individual setting is selected.

The de-curler table D1 set by the user is shown in the manager mode screen 314_10. In the de-curler table D1, “2” is selected as a penetration setting (setting value corresponding to the strength of the straightening force in the curl straightening section 900) in Simplex straight (mode in which the image is formed only on the single surface of the sheet and mode in which the sheet is discharged while the image formed surface is orientated upward). Then, when the curl straightening section 900 applies the straightening force having the strength corresponding to the setting value of “2”, the warp (upward arrow mark indicating the upper-curl) of the sheet passed through the curl straightening section 900 is animation-displayed. “6” is selected as the penetration setting in Simplex invert (mode in which the image is formed only on the single surface of the sheet and the sheet is discharged while the image formed surface is orientated downward). Then, when the curl straightening section 900 applies the straightening force having the strength corresponding to the setting value of “6”, the warp (downward arrow mark indicating the down-curl) of the sheet passed through the curl straightening section 900 is animation-displayed. In Duplex Side 1 (mode in which the images are formed in both the surfaces of the sheet and the sheet is discharged while the first surface in which the image is initially formed is orientated downward), a blank is displayed because the penetration setting is not performed. In Duplex Side 2 (mode in which the images are formed on both the surfaces of the sheet and the sheet is discharged while the second surface on which the second image is formed is orientated downward), “5” is selected as the penetration setting. Therefore, when the curl straightening section 900 applies the straightening force having the strength corresponding to the setting value of “5”, a straight arrow mark indicating no warp of the sheet passed through the curl straightening section 900 is animation-displayed. Thus, by means of the animation display, the user can easily recognize the relationship between the setting value selected in the penetration setting and the change in curl of the discharged sheet. Alternatively, the strength of the curl straightening force may be estimated while the setting value selected in the penetration setting is correlated with the current sheet type, current grammage band, and current sheet size displayed on the tray setting screen 310, and the warp of the sheet that is passed through the curl straightening section when the strength of the straightening force is applied may be animation-displayed.

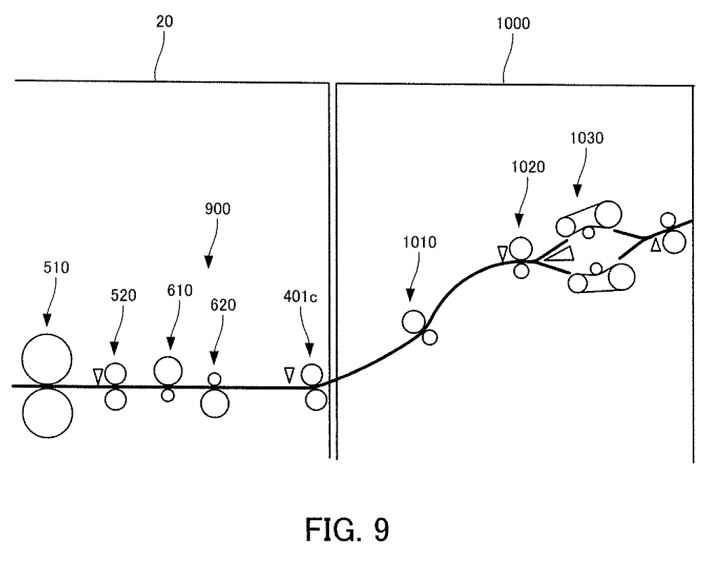

Referring to FIG. 1, sometimes an interface module (sheet feeding device) is attached to a side face (right of FIG. 1) of the main unit 20 of the image forming apparatus 1 of FIG. 1. At this point, possibly the sheet discharged from the main unit 20 is pulled out by the interface module. The detailed description will be made with reference to FIG. 9.

FIG. 9 shows a main unit illustrated in FIG. 1 and an interface module attached to the main unit.

Referring to FIG. 9, the main unit 20 includes the fixing section 510, the discharge roller 520, the curl straightening section 900 having the upper-curl straightening section 610 and the down-curl straightening section 620, and the discharge roller 401c. An interface module 1000 is attached to the side face of the main unit 20. An interface module 1000 includes a first conveyance roller 1010, a second conveyance roller 1020, and a curl straightening section 1030.

A sheet conveyance speed of the interface module 1000 provided on the downstream side in the sheet conveyance direction of the curl straightening section 900 is set faster than a sheet conveyance speed of the curl straightening section 900 for the purpose of the sheet feeding process and the like, and the sheet conveyance force of the interface module 1000 is regulated by a torque limiter. However, in the case where the curl straightening section 900 has the weak penetration setting (curl straightening section 900 has the weak straightening force), the sheet is pulled out from the curl straightening section 900. On the other hand, in the case where the curl straightening section 900 has the strong penetration setting (curl straightening section 900 has the strong straightening force), the sheet is hardly pulled out from the curl straightening section 900, thereby changing sheet running timing. Particularly, although the torque limiters are provided to the discharge roller 401c of the main unit 20 and the first conveyance roller 1010 of the interface module 1000, because the penetration setting value is variable, sometimes the torque limiter is activated and sometimes the torque limiter is not activated. Therefore, both the case in which the sheet is hardly pulled out when the torque limiter is activated and the case in which the sheet is pulled out when the torque limiter is not activated are generated to change a sheet interval, and possibly an adverse effect is generated in a process performed by a finisher.

Therefore, the penetration setting of the down-curl straightening section 620 of the curl straightening section 900 is set strong such that the sheet is not pulled out by the interface module 1000. However, because the sheet is down-curled, the penetration setting of the upper-curl straightening section 610 of the curl straightening section 900 is set strong such that the sheet is not down-curled.

A relation ship between a sheet fiber grain direction and the penetration setting of the curl straightening section 900 will be described. After the fixing, the curl amount and curl direction of the sheet are also changed by the sheet fiber grain direction (long direction and cross direction).

Usually an A3-size sheet mainly has the fiber in the cross direction with respect to the sheet lengthwise direction. An A4-size sheet mainly has the fiber in the long fiber direction with respect to the sheet lengthwise direction. Therefore, a table for cross/long fiber direction is prepared to correspond to the sheet size.

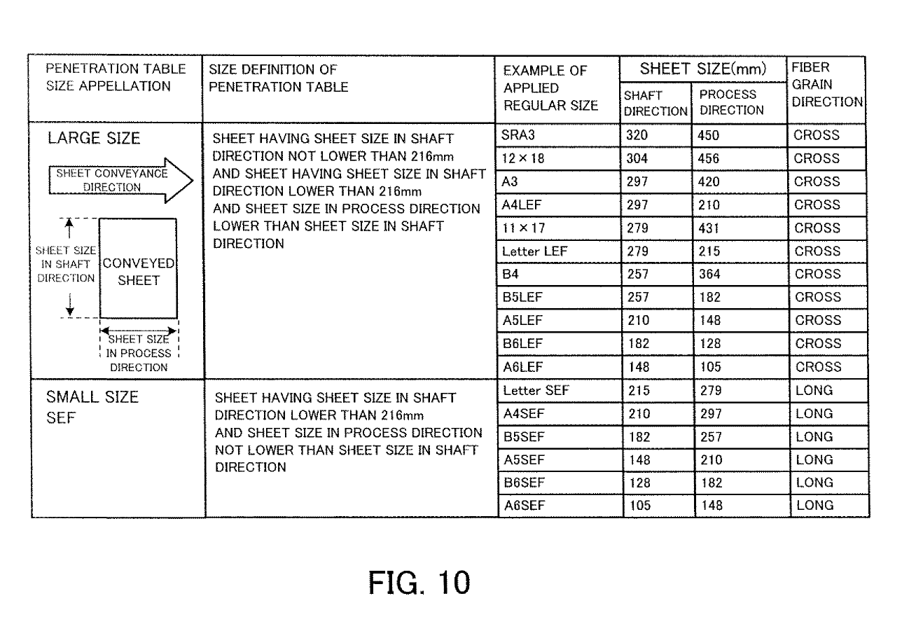

FIG. 10 is a table showing a correlation between the size sheet (large-size sheet and small-size sheet) and the fiber grain direction.

As shown in FIG. 10, it is assumed that the large-size sheet has the fiber in the cross direction with respect to the shaft direction (sheet lengthwise direction). That is, the large-size sheet has the fiber in the same direction as the process direction (sheet conveyance direction). On the other hand, it is assumed that the small-size sheet has the fiber in the long direction with respect to the shaft direction (sheet lengthwise direction). That is, the small-size sheet has the fiber in the same direction as the process direction (sheet conveyance direction).

In the sheets such as an A3-size SEF (Short Edge Feed) and an A4-size LEF (Long Edge Feed) which are of the large-size sheet, because the cross direction is formed in the sheet conveyance direction, the penetration amount of the curl straightening section 900 is set such that the curl amount of the sheet (short direction sheet) generated in the fixing device 510 is optimally de-curled. On the other hand, in an A4-size SEF sheet which is of the small-size sheet, because the long direction is formed in the sheet conveyance direction, the penetration amount of the curl straightening section 900 it set such that the curl amount of the sheet long direction sheet) generated in the fixing device 510 is optimally de-curled.

In the exemplary embodiment, the GUI 30 is provided. The setting value corresponding to the strength of the straightening force in the curl straightening section 900 that straightens the curl of the sheet after the fixing and the warp of the sheet passed through the curl straightening section 900 in applying the straightening force of the strength corresponding to the setting value in the curl straightening section 900 are displayed on the GUI 30, and the GUI 30 accepts the user's setting manipulation of the setting value. The curl straightening section 900 applies the straightening force having the strength based on the setting value set with the GUI 30 to the sheet after the fixing, thereby straightening the curl of the sheet.

The exemplary embodiment described above also serves as an exemplary embodiment of the image forming apparatus which will be described below.

The image forming apparatus includes: a sheet conveyance section that conveys the sheet; an image forming section that forms and transfers the toner image on the sheet conveyed by the sheet conveyance section according to the image signal; a fixing section that heats and pressurizes the sheet onto which the toner image is transferred to fix the toner image onto the sheet; and a curl straightening section that straightens curl of the sheet after the fixing, wherein the curl straightening section applies the straightening force so as to warp the curled sheet in the opposite direction, thereby straightening the curl of the sheet, herein the straightening force of the curl straightening section is freely adjusted, wherein the setting value corresponding to the strength of the straightening force in the curl straightening section that straightens the curl of the sheet after the fixing and the warp of the sheet passed through the curl straightening section in applying the straightening force of the strength corresponding to the setting value in the curl straightening section are displayed on a GUI, and the GUI accepts the user's setting manipulation of the setting value, wherein the curl straightening section applies the straightening force having the strength based on the setting value set with the GUI to the sheet after the fixing, thereby straightening the curl of the sheet.

The straightening force may be applied to the sheet after the fixing to straighten the curl of the sheet with the strength based on the setting value of the GUI, the sheet thickness, the ratio of the toner adhesion area on the sheet to the area of the sheet, and humidity.

According to the present invention, it is possible to straighten curl of paper heated in an ink-jet type of device.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a sheet conveyance section that conveys a sheet;
an image forming section that forms an image on the sheet conveyed by the sheet conveyance section according to an image signal;
a sheet heating section that heats the sheet on which the image is formed by the image forming section; and
a curl straightening section that straightens curl of the sheet after the sheet is heated by the sheet heating section,
wherein the sheet heating section curls the sheet in a different direction according to a sheet thickness, and
the curl straightening section includes:
a first curl straightening section that straightens the curl of the sheet curled in a first direction, the first direction being of a direction in which a relatively thick sheet is curled by the sheet heating section; and
a second curl straightening section that is disposed on a downstream side in a sheet conveyance direction of the sheet conveyance section to straighten the curl of the sheet curled in a second direction, the second direction being of an opposite direction to the first direction.

2. The image forming apparatus according to claim 1, further comprising a sheet type information obtaining section that obtains sheet type information,
wherein each of the first curl straightening section and the second curl straightening section straightens the curl of the sheet by applying a straightening force to warp the curled sheet in an opposite direction, the straightening force is adjustable, and
the curl straightening section includes an adjustment section which adjusts the straightening forces of the first curl straightening section and the second curl straightening section according to the sheet type information obtain by the sheet type information obtaining section.

3. The image forming apparatus according to claim 2, wherein the adjustment section obtains sheet thickness information, image density information indicating a ratio of an image formation area on the sheet to an area of the sheet, and humidity information indicating environmental humidity, and adjusts the straightening forces of the first curl straightening section and the second curl straightening section according to the sheet thickness information, the image density information, and the humidity information.

4. The image forming apparatus according to claim 1, wherein the first curl straightening section includes:
a first curl straightening shaft that drives the conveyed sheet; and
a first curl straightening roller that is disposed in parallel with the first curl straightening shaft, the first curl straightening roller pressing the sheet against the first curl straightening shaft while the sheet is nipped between the first curl straightening roller and the first curl straightening shaft, and
the second curl straightening section includes:
a second curl straightening shaft that drives the conveyed sheet while contacting a second surface of the sheet, the second surface being of a backside of a first surface contacting the first curl straightening shaft; and
a second curl straightening roller that is disposed in parallel with the second curl straightening shaft, the second curl straightening roller pressing the sheet against the second curl straightening shaft while the sheet is nipped between the second curl straightening roller and the second curl straightening shaft.

5. The image forming apparatus according to claim 4, wherein the first curl straightening section includes a first cam mechanism that applies a first pressing force to the first curl straightening roller according to a cam position in order to press the first curl straightening shaft through a cam,
the second curl straightening sect-on includes a second cam mechanism that applies a second pressing force to the second curl straightening roller according to a cam position in order to press the second curl straightening shaft through a cam, and
the curl straightening section includes an adjustment section that obtains sheet thickness information, drives the first cam mechanism and the second cam mechanism according to the sheet thickness information, thereby adjusting the first pressing force and the second pressing force.

6. The image forming apparatus according to claim 5, wherein the adjustment section obtains sheet thickness information, image density information indicating a ratio of a toner adhesion area on the sheet to an area of the sheet, and humidity information indicating environmental humidity, and adjusts the first pressing force and the second pressing force by driving the first cam mechanism and the second cam mechanism according to the sheet thickness information, the image density information, and the humidity information.

7. The image forming apparatus according to claim 4, wherein the first curl straightening section and the second curl straightening section are formed into one assembly.

8. An image forming apparatus comprising
a sheet type information obtaining section that obtains sheet type information;
a sheet conveyance section that conveys a sheet;
an image forming section that forms an image on the sheet conveyed by the sheet conveyance section according to an image signal;
a sheet heating section that heats the sheet on which the image is formed by the image forming section; and
a curl straightening section that straightens curl of the sheet after the sheet is heated by the sheet heating section,
wherein the curl straightening section includes:
a first curl straightening section that straightens the curl of the sheet curled in a first direction; and
a second curl straightening section that straightens the curl of the sheet curled in a second direction, the second direction being of an opposite direction to the first direction,
each of the first curl straightening section and the second curl straightening section straightens the curl of the sheet by applying a straightening force to warp the curled sheet in an opposite direction, the straightening force is adjustable, and
the curl straightening section includes an adjustment section which adjusts the straightening forces of the first curl straightening section and the second curl straightening section according to the sheet type information obtained by the sheet type information obtaining section.

9. A curl straightening device that straightens curl of a sheet after the sheet is heated by a sheet heating section, the curl straightening device curling the sheet in a different direction according to a sheet thickness, the curl straightening device comprising:
a first curl straightening section that straightens the curl of the sheet curled in a first direction, the first direction being of a direction in which a relatively thick sheet is curled by the sheet heating section, and
a second curl straightening section that is disposed on a downstream side in a sheet conveyance direction of the sheet conveyance section to straighten the curl of the sheet curled in a second direction, the second direction being of an opposite direction to the first direction.

10. The curl straightening device according to claim 9, further comprising a sheet type information obtaining section that obtains sheet type information,
wherein each of the first curl straightening section and the second curl straightening section straightens the curl of the sheet by applying a straightening force to warp the curled sheet in an opposite direction, the straightening force is adjustable, and
the curl straightening section includes an adjustment section which adjusts the straightening forces of the first curl straightening section and the second curl straightening section according to the sheet type information obtained by the sheet type information obtaining section.

11. The curl straightening device according to claim 10, wherein the adjustment section obtains sheet thickness information, image density information indicating a ratio of an image formation area on the sheet to an area of the sheet, and humidity information indicating environmental humidity, and adjusts the straightening forces of the first curl straightening section and the second curl straightening section according to the sheet thickness information, the image density information, and the humidity information.

12. The curl straightening device according to claim 9, wherein the first curl straightening section includes:
a first curl straightening shaft that drives the conveyed sheet; and
a first curl straightening roller that is disposed in parallel with the first curl sraightrening shaft, the first curl straightening roller pressing the sheet against the first curl straightening shaft while the sheet is nipped between the first curl straightening roller and the first curl straightening shaft, and
the second curl straightening section includes:
a second curl straightening shaft that drives the conveyed sheet while contacting a second surface of the sheet, the second surface being of a backside of a first surface contacting the first curl straightening shaft; and
a second curl straightening roller that is disposed in parallel with the second curl straightening shaft, the second curl straightening roller pressing the sheet against the second curl straightening shaft while the sheet is nipped between the second curl straightening roller and the second curl straightening shaft.

13. The curl straightening device according to claim 12, wherein the first curl straightening section includes a first cam mechanism that applies a first pressing force to the first curl straightening roller according to a cam position in order to press the first curl straightening shaft through a cam,
the second curl straightening section includes a second cam mechanism that applies a second pressing force to the second curl straightening roller according to a cam position in order to press the second curl straightening shaft through a cam, and
the curl straightening section includes an adjustment section that obtains sheet thickness information, drives the first cam mechanism and the second cam mechanism according to the sheet thickness information, thereby adjusting the first pressing force and the second pressing force.

14. The curl straightening device according to claim 12, wherein the adjustment section obtains sheet thickness information, image density information indicating a ration of an image formation area on the sheet to a area of the sheet, and humidity information indicating environmental humidity, and adjusts the first pressing force and the second pressing force by driving the first cam mechanism and the second cam mechanism according to the sheet thickness information, the image density information, and the humidity information.

15. The curl straightening device according to claim 12, wherein the first curl straightening section and the second curl straightening section are formed into one assembly.
